(19) United States
(12) Patent Application Publication
(10) Pub. No.: US 2022/0083950 A1
(43) Pub. Date: Mar. 17, 2022

(54) SYSTEM AND METHOD FOR SKILLED MARKETPLACE SCHEDULING

(71) Applicant: YourMechanic, Inc., San Jose, CA (US)

(72) Inventors: Rajat Agarwal, San Jose, CA (US); Xue Han, San Jose, CA (US)

(21) Appl. No.: 17/478,430

(22) Filed: Sep. 17, 2021

Related U.S. Application Data
(60) Provisional application No. 62/706,904, filed on Sep. 17, 2020.

(51) Int. Cl. G06Q 10/06; G06Q 30/02

(52) U.S. Cl. CPC G06Q 10/063112; G06Q 30/0201; G06Q 30/0205; G06Q 10/063116

(57) ABSTRACT

A skilled service marketplace scheduling system and method is provided. The system can include a skilled service marketplace coordination system, one or more skilled service marketplace requester devices, and one or more skilled service marketplace provider devices. The coordination system may determine a schedule given a skilled service marketplace request and a skilled service marketplace provider schedule. The coordination system may assign a given request to a skilled service provider based on the skill level of the skilled service provider. The coordination system can account for travel time between the requester and the skilled service provider. The system may interact with third party systems, such as a parts inventory, to create the skilled service marketplace schedule. The system can confirm adequate performance of the skilled service.

### BACKGROUND OF THE INVENTION

The present invention relates to a skilled marketplace scheduler, particularly a system and method for balancing work requests among a plurality of skilled technicians.

In the service industry, there are a variety of service-based marketplaces that involve scheduling. The service providers participating in these service-based marketplaces may have varied levels of skill. In some cases, the marketplace may demand a minimum competency for listing services. In other cases, any service provider can participate in the marketplace and earn compensation for their services.

Known service scheduling systems have a reduced number of external dependencies on third party systems for inputs and thus the operation of these systems may be less impacted by such third party system inputs.

Known service scheduling systems do not account for a wide variation on skills and equipment of the participating service providers. Instead, in general, existing scheduling systems either presume all service providers have the same skills and equipment or they account for differences in skill sets and equipment in a rudimentary way.

These and other factors can contribute to known scheduling systems' inability to accurately confirm performance of a service. To the extent that scheduling systems can confirm performance of a service, it is typically through a complicated confirmation process. While some scheduling systems aim to increase performance, efficiency, and reliability of the scheduling system, the existing options fall short.

There is thus a need for a skilled service marketplace scheduler that can account for multiple real world inputs.

### SUMMARY OF THE INVENTION

In one aspect, a skilled service marketplace scheduling system is provided. The skilled marketplace scheduling system may include a skilled marketplace requester device, a plurality of skilled service marketplace provider devices, and a skilled service marketplace coordination system. Each of the components may include its own communication module. The skilled service marketplace coordination system can include a skilled service marketplace coordination processor in communication with the skilled service marketplace coordination communication module. The skilled service marketplace requester device may send a skilled service marketplace request to the skilled service marketplace coordination system. Each of the plurality of skilled service marketplace provider devices may send a skilled service marketplace provider schedule to the skilled service marketplace coordination system.

The skilled service marketplace coordination communication system can calculate a plurality of available time slots for the skilled service marketplace request based on the skilled service marketplace provider schedules. In one aspect, the skilled service marketplace coordination device may determine the available time slots by compiling a list of all available appointment slots based on the skilled service marketplace provider schedules and filtering the list based on the opportunity cost for each appointment slot in the list of all available appointment slots. For each of the skilled technicians, the skilled service marketplace coordination processor may calculate a target rate. For each of the available time slots and for each qualified and available skilled technician of the plurality of skilled technicians associated with the respective time slots, the skilled service marketplace coordination processor may calculate a prospective rate. The prospective rate may be based on the skilled technician's current rate and the rate for the skilled service marketplace request. The skilled service marketplace coordination processor can calculate a target differential between the target rate and the prospective rate for each of the skilled technicians in the set of available qualified skilled technicians. The skilled service marketplace coordination processor can assign the skilled service marketplace request to the skilled technician in the set of available qualified skilled technicians based upon the target differential.

In one aspect, the skilled service marketplace coordination processor can utilize at least one of paid utilization, minimum utilization, opportunity, and performance boost to calculate the target differential.

In another aspect, each of the skilled service marketplace requester device, plurality of skilled service marketplace provider devices, and skilled service marketplace coordination system may include a processor, a memory, and a communication module. The skilled service marketplace coordination processor can select a skilled technician from among a plurality of skilled technicians to perform the skilled service marketplace requests in an appointment slot. In one aspect, the plurality of skilled technicians may be a subset of all skilled technicians in the system that have a skills inventory corresponding to the skilled service marketplace requests. The skilled service marketplace coordination processor can create a skilled service marketplace coordination schedule based on the skilled service marketplace request and the skilled service marketplace provider schedules. The skilled service marketplace coordination schedule may include a skilled service requester appointment schedule and a skilled service provider service schedule. The skilled service marketplace coordination memory may store the skilled service marketplace coordination schedule. The skilled service marketplace coordination communication module can transmit the skilled service requester appointment schedule to the skilled service marketplace requester device and the skilled service marketplace requester memory may store the skilled service requester appointment schedule. The skilled service marketplace coordination communication module can transmit the skilled service provider service schedule to the skilled service marketplace provider device corresponding to the chosen skilled technician and the skilled service marketplace provider memory may store the skilled service provider service schedule.

In one aspect, the skilled service marketplace provider schedule may include a schedule of availability, a compensation information, a tools inventory, and a skills inventory. The skills inventory may include a list of certifications for the skilled technician. The schedule of availability can be at least one of availability for an individual skilled technician and availability for a plurality of skilled technicians.

In one aspect, the skilled service marketplace coordination processor can compute a list of expected skilled service marketplace requests in a first time period. The skilled service marketplace coordination processor can determine a demand for a higher level of skill in the first time period from the list of expected skilled service marketplace requests. The skilled service marketplace coordination processor may determine whether the demand for the higher level of skill will keep the skilled technicians with the skills inventory corresponding to the higher level of skill sufficiently busy in the first time period. Upon receiving a skilled service marketplace request for a skilled service utilizing a lower level of skill in the first time period, the skilled service marketplace coordination processor can select a skilled technician with a lower level of skill to perform the skilled service marketplace request if the skilled technicians with the skills inventory corresponding to the higher level of skill will be sufficiently busy with the demand for the higher level of skill in the first time period.

In one aspect, each of the skilled service marketplace requester communication module and the skilled service marketplace provider communication module may transmit a geographic location to the skilled service marketplace coordination communication module. The skilled service marketplace coordination processor can use the geographic locations to determine the skilled service marketplace coordination schedule. In one aspect, the skilled service marketplace coordination processor may use the geographic location received from the skilled service marketplace requester device and the skilled service marketplace provider device to compute a skilled technician travel time. The skilled service marketplace coordination processor can select a skilled technician from the plurality of skilled technicians to perform the skilled service marketplace request if the chosen skilled technician has a time available for both the skilled service marketplace request and the skilled technician travel time.

In one aspect, the skilled service marketplace requests may have a set of service characteristics. The set of service characteristics can include a pre-determined amount of time to perform the requested service and a cost corresponding to the requested service.

In one aspect, the skilled service marketplace coordination memory may store a parts inventory. The skilled service marketplace coordination processor may check the parts inventory when it receives a skilled service marketplace request to determine whether a set of parts used for the skilled service marketplace request are available in the parts inventory. The skilled service marketplace coordination communication module can send a service unavailable message to the skilled service marketplace requester communication module when the set of parts is not available in the parts inventory. The skilled service marketplace coordination processor may decrement the number of parts available in the parts inventory when a skilled service marketplace request is incorporated into the skilled service marketplace coordination schedule.

In one aspect, the skilled service marketplace coordination processor may calculate a score for each skilled technician in the plurality of skilled technicians based on the target differential, paid utilization, minimum utilization, opportunity, and performance boost. The skilled service marketplace coordination processor can select the chosen skilled technician as the skilled technician with the highest score.

In one aspect, a method of skilled marketplace scheduling is provided. A skilled service marketplace coordination device may receive a skilled service marketplace request from a skilled service marketplace requester device. The skilled service marketplace coordination device can receive skilled service marketplace provider schedules from at least one of a plurality of skilled service marketplace provider devices. The skilled service marketplace coordination device may determine a plurality of skilled service available appointment slots.

The skilled service marketplace coordination device may use the skilled service marketplace provider schedules to select a chosen skilled technician to complete the skilled service marketplace request in one of the skilled service available appointment slots. The skilled service marketplace coordination device can create a skilled marketplace coordination schedule based on the skilled service marketplace request and the skilled service marketplace provider schedules. The skilled marketplace coordination schedule may include skilled service requester appointment schedules and skilled service provider service schedules. The skilled marketplace coordination device may include a skilled marketplace coordination memory and may store the skilled marketplace coordination schedule in the skilled service marketplace coordination memory. The skilled service marketplace coordination device can transmit the skilled service requester appointment schedule to the skilled service marketplace requester device. The skilled service marketplace coordination device can transmit the skilled service provider service schedule to the skilled service marketplace provider device corresponding to the chosen skilled technician.

These and other objects, advantages, and features of the invention will be more fully understood and appreciated by reference to the description of the current aspect and the drawings.

Before the aspects of the invention are explained in detail, it is to be understood that the invention is not limited to the details of operation or to the details of construction and the arrangement of the components set forth in the following description or illustrated in the drawings. The invention may be implemented in various other aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various aspects. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is an overview of a system for skilled marketplace scheduling according to one aspect.

FIG. 2 is a flowchart of a method for skilled marketplace scheduling according to one aspect.

FIG. 3 is a flowchart of a simulation procedure for skilled marketplace scheduling according to one aspect.

FIG. 4 is a flowchart of an all-provider simulation for skilled marketplace scheduling according to one aspect.

FIG. 5 is a flowchart of a single-provider simulation for skilled marketplace scheduling according to one aspect.

FIG. 6 is a flowchart of a simulation per demand trial for skilled marketplace scheduling according to one aspect.

FIG. 7 is a flowchart of a single-quote procedure for skilled marketplace scheduling according to one aspect.

FIG. 8 is a flowchart of a single-provider procedure for skilled marketplace scheduling according to one aspect

FIG. 9 is a flowchart of a time slot evaluation procedure for skilled marketplace scheduling according to one aspect.

FIG. 10 is a system diagram for a system for skilled marketplace scheduling according to one aspect.

FIG. 11 is a system for skilled marketplace scheduling according to one aspect.

### DESCRIPTION OF THE CURRENT ASPECTS

A skilled service marketplace scheduling system and method is provided.

A skilled service provider is an individual who delivers the requested service to the requester. The skilled service provider may be alternately referred to as a skilled service marketplace provider or a skilled technician. The skilled service provider may be known to have a specific set of availability, serve a geographical area, and have a specific set of capabilities. In one aspect, the set of capabilities can include skills and tools.

In one aspect, the skilled service marketplace scheduling system of the present disclosure may schedule skilled service marketplace requests based on skilled service provider outcomes as seen in the recent past and as projected for the near future. The skilled service marketplace request may alternately be referred to as a quote or a job. One example skilled service provider outcome is compensation. The skilled service marketplace scheduling system can account for the supply and demand within a given geographical region, the performance and quality of the skilled service providers and their skills and availability, and the systems and processes that provide the scheduling and confirm performance. The skilled service marketplace scheduling system may optimize the Paid Utilization of the skilled service provider schedules by accounting for any inefficiencies as an opportunity cost.

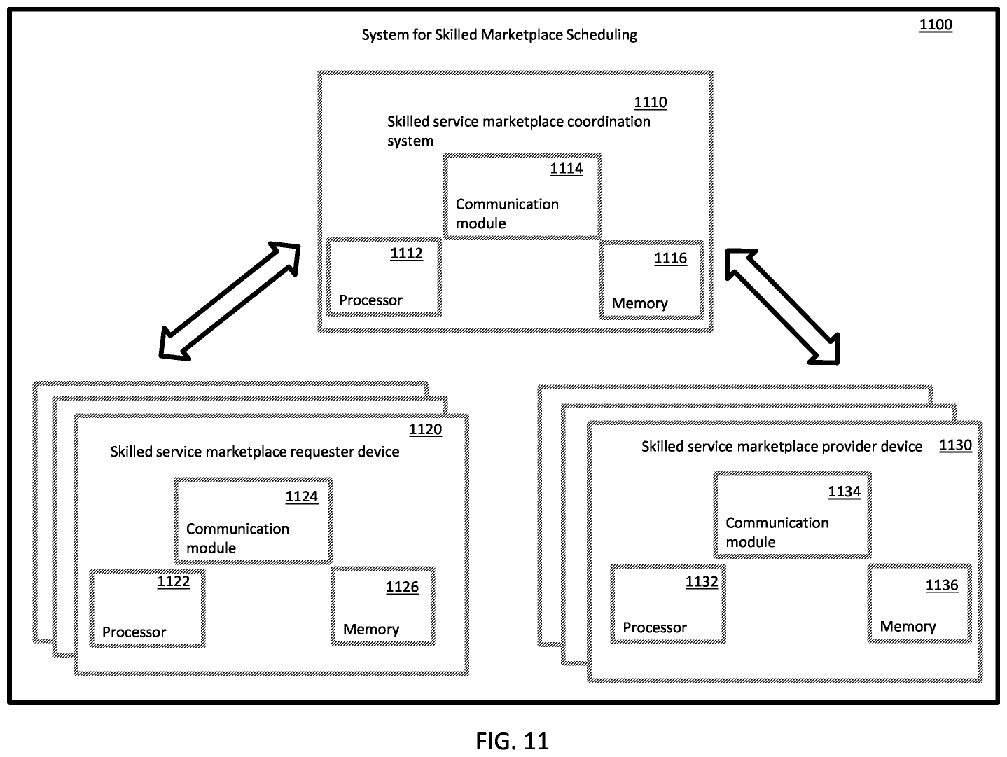

In FIG. 11, a system for skilled marketplace scheduling 1100 is shown according to one aspect. The system 1100 may include a skilled service marketplace coordination system 1110, one or more skilled service marketplace requester devices 1120, and one or more skilled service marketplace provider devices 1130. As depicted in FIG. 11, each of these components may have a processor 1112, 1122, 1132, a communication module 1114, 1124, 1134, and a memory 1116, 1126, 1136. Each processor 1112, 1122, 1132 can be in communication with its respective communication module 1114, 1124, 1134, and respective memory 1116, 1126, 1136. In an alternate aspect, each component may have additional or fewer components. For example, in some embodiments each component may include a subset of a processor, communication module, and memory. The skilled service marketplace requester device 1120 and the skilled service marketplace provider device 1130 may each be in bidirectional communication with the skilled service marketplace coordination system 1110, for example over a network.

Each of the coordination system 1110, the requester device 1120, and the provider device 1130 may include one or more microcontrollers, microprocessors, and/or other programmable electronics that are programmed to carry out various functionality, which are described herein. The system 1100 may additionally or alternatively include other electronic components that are programmed to carry out the functions described herein, or that support the microcontrollers, microprocessors, and/or other electronics. The other electronic components can include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in another manner, whether combined into a single unit or distributed across multiple units. Such components may be physically distributed in different positions in the system 1100, or they may reside in a common location within the system 1100. The components may communicate using any suitable communication protocol and hardware.

In one aspect, the skilled service marketplace coordination system 1110 may be implemented in dedicated hardware. In an alternate aspect, the coordination system 1110 can be implemented virtually, for example using cloud computing. In yet another aspect, the coordination system 1110 may be implemented in a combination of dedicated hardware and virtual hardware, e.g., a cloud computing system.

Returning to FIG. 11, the skilled service marketplace requester device 1120 may be configured to transmit a skilled service marketplace request, for example via communication module 1124. The skilled service marketplace request may alternatively be referred to as a service request or a quote. The skilled service marketplace request can be defined as a unit of demand. Put another way, the skilled service marketplace request is a request from a skilled service marketplace requester, such as a customer, specifying the parameters of a requested skilled service. The parameters included in the request can be hardcoded or selected from a pre-defined set of available parameters. The values of the parameters included in the request can be selected from pre-defined choices (e.g., using a slider or other user interface selection tool) or can be directly input by the user. In one aspect, the parameters of a requested skilled service may include the location where the service will be performed. Each skilled service marketplace request has a set of characteristics. For example, in one aspect, the characteristics may include skills, tools, location, labor time, and external dependencies, such as parts used in the service. In one aspect, the characteristics can include a pre-determined amount of time to perform the requested service and a cost corresponding to the requested service. In one aspect, a skilled service marketplace request in the skilled marketplace of auto mechanics may have the following characteristics: (1) a particular service (e.g. an oil change), (2) a make and model of the car, and (3) the geographic location where the service is to be performed. In one aspect, the geographic location is a zip code. The set of characteristics can be packed into a set of one or more identifiers that reference a database. For example, the characteristics may include a service identifier, a vehicle identifier, and a geographic identifier. The identifiers can be referenced against suitable databases to look-up the associated services, vehicles, and locations. Throughout the application reference to such characteristics may refer either to a request that includes the characteristics or identifiers to such characteristics.

In one aspect, the coordination system 1110 can allow the requester to specify a price (or price range) they are willing to pay for a given skilled service marketplace request. In an alternate aspect, the price for the skilled service marketplace request is set by the system 1100. In yet another aspect, the price for the skilled service marketplace request may vary based on the skillset of the skilled service provider and/or other factors. In yet another aspect, the skilled service provider can set the price for their services either on a time basis, per skilled service marketplace request, or according to another metric.

The skilled service marketplace provider device communication 1134 may be configured to transmit skilled service marketplace provider schedules. In one aspect, a skilled service provider may input their availability to the system via an interface of the skilled service marketplace provider device 1130. The availability can be denoted in a variety of different formats, in one aspect availability is expressed via a plurality of Available Intervals that represent contiguous chunks of time the service provider is available to work on service requests. That is, an Available Interval may be defined as uninterrupted and continuous available block of calendar time. For instance, if a skilled service provider is available from 9:00 AM to 12:00 PM, the skilled service provider has an Available Interval of three hours. By way of example, if an appointment is booked from 10:00 AM to 11:00 AM for this skilled service provider, the skilled service provider now has two Available Intervals of one hour each (from 9:00 AM to 10:00 AM and from 11:00 AM to 12:00 PM).

The skilled service marketplace coordination system 1110 (e.g., processor 1112) may calculate a plurality of available time slots for the skilled service marketplace request received from the skilled service marketplace requester device 1120 based on the skilled service marketplace provider schedules received form the skilled service marketplace provider device 1130. A time slot can be defined as a unit of availability defined by a day and a start time. When a requester is presented with available time slots for their skilled service marketplace request, the presented time slots may be referred to as Requester Visible Availability. The Requester Visible Availability may be defined as the availability for a given skilled service marketplace request presented to the customer as options for creating an appointment for the skilled service marketplace request. A time slot can refer to Skilled Service Provider Availability or Requester Visible Availability.

The skilled service marketplace coordination communication module 1114 can transmit the plurality of available time slots to the skilled service marketplace requester device 1120. The requester communication module 1124 may receive a user selection of a selected time slot from the plurality of available time slots and transmit the selected time slot to the coordination communication module 1114. In an alternate aspect, the requester device 1120 may send one or more time slots to the coordination system 1110 that the requester has indicated as available for the skilled service marketplace request. The coordination system 1110 may then select a time slot for the skilled service request based on the time slots the requester has indicated as available and the skilled service marketplace provider schedules. In one aspect, the plurality of time slots may be provided such that the requester does not see the skilled service provider(s) available in that time slot. This may promote system efficiency because the requester may not be overwhelmed by choices. In an alternate aspect, the requester can be presented with all available skilled service providers in the available time slots and the requester may select their desired skilled service provider.

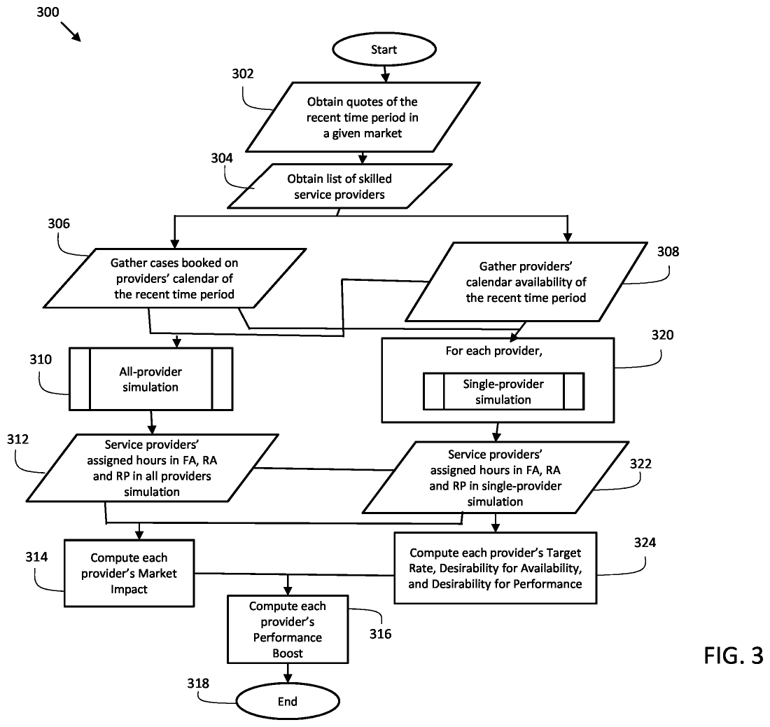

The skilled service marketplace coordination processor 1112 may determine a set of available qualified skilled technicians for the skilled service marketplace request in the selected time slot. The coordination processor 112 can calculates a Target Rate and a Prospective Rate for each skilled technician in the set of available qualified skilled technicians. The Target Rate may alternatively be referred to as a target pay rate or target compensation. The Target Rate may be defined as an optimistic Pay Rate calculated per skilled service provider accounting for the demand within a market and the Skilled Service Provider Capabilities, Skilled Service Provider Availability, and Skilled Service Provider Yield/Performance. These concepts are defined below with reference to FIG. 3.

A market may be defined as a geographical region serviced by one or more skilled service providers. Markets are generally disjoint and may be treated independently.

The coordination processor 1112 may calculate a Target Differential between the Target Rate and the Prospective Rate for each skilled technician in the set of available qualified skilled technicians. The coordination processor 1112 can assign the skilled service marketplace request to the skilled technician in the set of available qualified skilled technicians with the highest Target Differential. In one aspect, the skilled service marketplace coordination processor may calculate the target differential based on at least one of Paid Utilization, Minimum Utilization, Opportunity, and Performance Boost to calculate the target differential.

In one aspect, the coordination communication module 1114 may be configured to: (1) receive skilled service marketplace requests; (2) receive skilled service marketplace provider schedules; (3) receive skilled service requester selected appointment slots; (4) transmit skilled service available appointment slots; (5) transmit skilled service requester appointment schedules; and (6) transmit skilled service provider service schedules. The requester communication module 1124 may be configured to: (1) transmit skilled service marketplace requests; (2) transmit skilled service requester selected appointment slots; (3) receive skilled service available appointment slots; and (4) receive skilled service requester appointment schedules. The provider communication module can be configured to: (1) transmit skilled service marketplace provider schedules; and (2) receive skilled service provider service schedules. The skilled service provider service schedules include service appointments.

The coordination processor 1112 may create a skilled service marketplace coordination schedule based on the skilled service marketplace requests, the skilled service marketplace provider schedules, and the service requester selected appointment slots. The skilled service marketplace coordination schedule can include the skilled service requester appointment schedules and the skilled service provider service schedules. The skilled service marketplace coordination memory 1116 may store the skilled service marketplace coordination schedule. The skilled service marketplace requester memory 1126 can store the skilled service requester appointment schedules. The skilled service marketplace provider memory 1136 may store the skilled service marketplace provider schedules and the skilled service provider service schedules.

In one aspect, a skilled service marketplace provider schedule may include a schedule of availability. The schedule of availability may be the availability for one skilled service provider. In an alternate aspect, the schedule of availability may be the availability for a plurality of skilled service providers. Additionally, or alternatively, the provider schedule can include a compensation information. Additionally, or alternatively, the provider schedule can include a tools inventory. Additionally, or alternatively, the provider schedule may include a skills inventory. The skills inventory may include a list of certifications for the skilled service marketplace provider.

For some skilled services, and some entire skilled markets, skilled service marketplace requests may be performed without tools. For example, in the skilled marketplace of auto mechanics, a request for a virtual or telephonic diagnostic appointment does not utilize any tools.

In one aspect, the coordination processor 1112 can calculate an expected demand on the system for skilled marketplace scheduling 1110. The coordination processor 1112 may compute a list of expected skilled service marketplace requests in a first time period. The list of expected skilled service marketplace requests may be based on recent and/or historical data. The coordination processor 1112 may determine an expected demand for a higher level of skill in the first time period based on the list of expected requests. In one aspect, whether a given request utilizes a higher level of skill may be determined from the characteristics of the skilled service marketplace request. In one aspect, the level of skill may correspond to the number of skills a given skilled service provider possesses. For example, a higher level of skill may correspond to a skilled service provider that has a larger number of skills. In one aspect, the level of skill can correspond to the proficiency a skilled technician has in a given skill. For example, a skilled technician with a higher level of skill may have a greater proficiency in a given skill. In one aspect, a higher level of skill can refer to the skill required for a skilled service request that is more difficult to perform than at least some other skilled service request.

The coordination processor 1112 can determine whether the expected demand for the higher level of skill will keep the skilled technicians qualified to perform such skilled services sufficiently busy in the first time period. In one aspect, the coordination processor 1112 may make this determination by comparing the amount of time for the expected higher level of skill requests with the available time for the qualified skilled technicians. If the amount of time for the expected higher level of skill requests is a certain threshold of the available time, the coordination processor 1112 can determine that the skilled technicians will be sufficiently busy. If the coordination processor 1112 determines that the skilled technicians with a higher level of skill are expected to be sufficiently busy, the coordination processor may assign a skilled service marketplace request with a lower level of skill to a skilled technician with a lower amount of skill. If not, the coordination processor 1112 can follow its regular procedure for assigning skilled service marketplace requests.

In one aspect, the demand for skilled services may be affected by seasonality. Seasonality can be defined as repeated variations of demand over the course of a year. Seasonality may affect all skilled services in a market or a subset of the skilled services.

In one aspect, the requester communication module 1124 and the provider communication module 1134 may transmit a geographic location to the coordination communication module 1114. In one aspect, the requester geographic location can correspond to the desired service location for the skilled service marketplace request. In one aspect, the provider geographic location may correspond to the market the skilled service provider services. In another aspect, the provider geographic location can correspond to the skilled service provider's expected location prior to the selected time slot for a given skilled service marketplace request. The coordination processor 1112 may use the requester geographic location and the provider geographic location to determine the skilled service marketplace coordination schedule.

In one aspect, the coordination processor 1112 may use the requester geographic location and the provider geographic location to determine a skilled technician travel time. In one aspect, the skilled technician travel time can be added to the performance time of the skilled service marketplace request to become a total appointment time. The coordination processor 1112 may select a skilled technician to perform the skilled service marketplace request if the skilled technician has a time slot available for both the skilled service marketplace request and the skilled technician travel time.

For some skilled services, and some entire skilled markets, the performance of the skilled service does not depend on any geographic location. In the skilled marketplace of auto mechanics, for example, a diagnostic visit with an auto mechanic can be performed telephonically or virtually and thus the geographic location of the skilled service is irrelevant. A diagnostic visit may help ensure the correct service for the issue is scheduled.

In one aspect, the skilled service technician travels to the requester to perform the service. With reference to the skilled marketplace of auto mechanics, other scenarios are now described. In one aspect, the car may be taken to the service location (e.g. by a tow truck or valet). In another aspect, the requester may drive the car to the shop. In another aspect, the auto mechanic and the requester meet at a mutually agreed upon location. For example, if the requester is purchasing a vehicle, the requester and the auto mechanic can agree to meet at the seller's location for the auto mechanic to perform the skilled service of a car inspection before the requester purchases the car. In another example, the requester and the auto mechanic may agree to meet at a third party garage or other place more suitable to perform the skilled service than the requester's home. In yet another aspect, any other suitable location or variation upon travel may be used.

In one aspect, the coordination memory 1116 can store a parts inventory. The skilled service marketplace coordination system 1110 may generate and/or maintain the parts inventory independently. In an alternate aspect, the coordination system 1110 may communicate with a third party service to receive and/or update the parts inventory. The coordination processor 1112 can check the parts inventory when it receives a skilled service marketplace request to determine whether a set of parts to fulfil the skilled service marketplace request is available in the parts inventory. If the coordination processor 1112 determines that the set of parts is not available, the coordination processor 1112 may discard the skilled service marketplace request. In one aspect, the coordination communication module 1114 may send a notification, such as a service unavailable message, to the requester through the requester device 1120 to notify the requester that the requested service is unavailable in a given time frame. If the coordination processor 1112 determines that the set of parts is available, the coordination processor 1112 can decrement the set of parts from the available parts in the parts inventory. In one aspect, the coordination processor 1112 may decrement the number of available parts when the skilled service marketplace request is incorporated into the skilled service marketplace coordination schedule. In another aspect, the coordination processor 1112 may decrement the number of available parts when performance of the skilled service marketplace request has been confirmed.

Some skilled services, and entire skilled markets, do not utilize parts for skilled service performance. For example, in the skilled marketplace of auto mechanics, a diagnostic service request can be performed without any parts. In one aspect, a diagnostic service may utilize tools.

In one aspect, the coordination processor 1112 may only consider a subset of skilled technicians for a given skilled service marketplace request when the skills inventory of the skilled technicians corresponds to the skilled service marketplace request.

In one aspect, the requester device 1120 and the provider device 1130 may send information to the coordination system 1110 as and when called for or as updated information is available. The requester device 1120 and the provider device 1130 can determine when to send information to the coordination system 1110. In an alternate aspect, the coordination system 1110 may request information from the requester device 1120 and the provider device 1130.

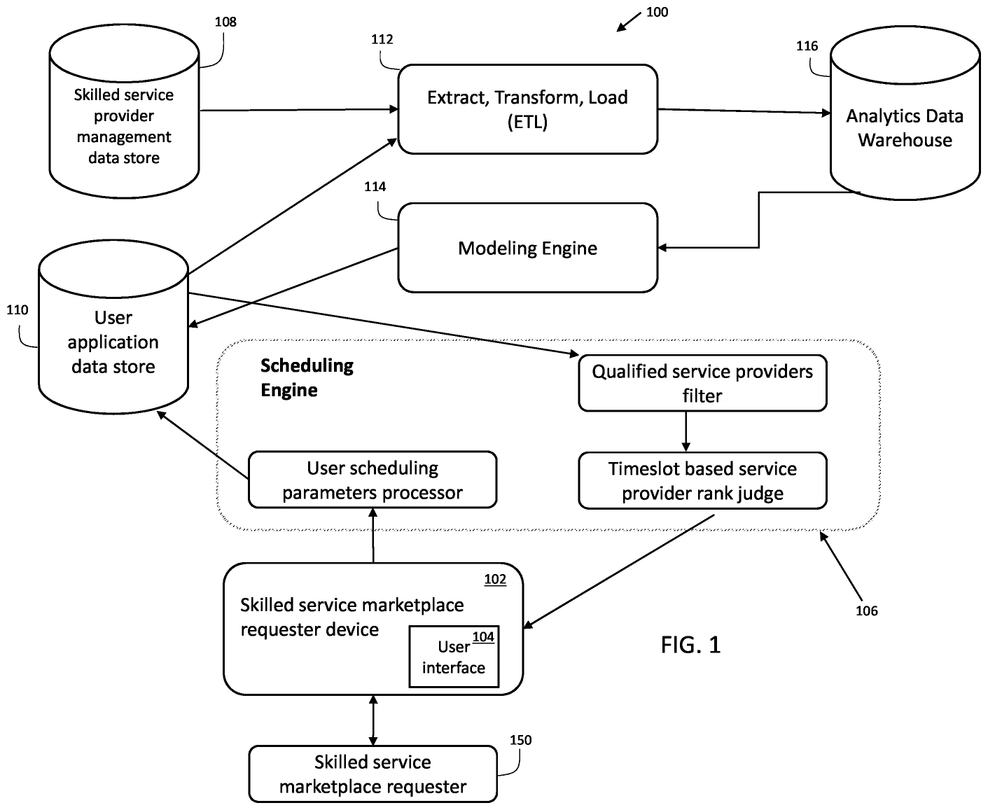

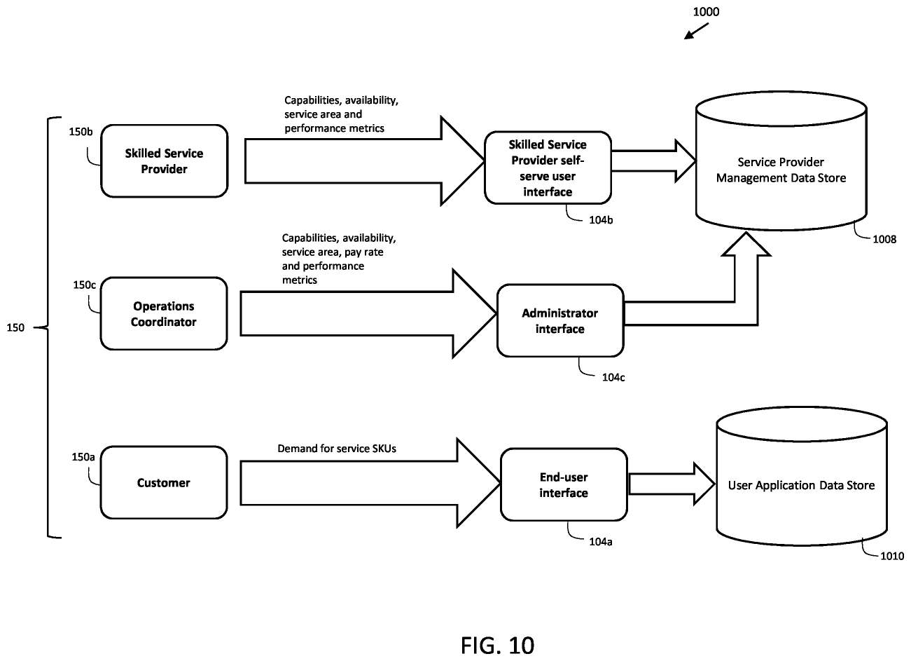

In FIG. 1, an overview of a system for skilled marketplace scheduling 100 according to one aspect is shown. The system for skilled marketplace scheduling 100 may include a skilled service marketplace requester 150 accessing a skilled service marketplace requester device 102. The skilled service marketplace requester 150 may be a customer 150a, a skilled service provider 150b, or an operations coordinator 150c as shown in FIG. 10.

In FIG. 10, a system diagram for a system for skilled marketplace scheduling 1000 according to one aspect is shown. In one aspect, the customer 150a can submit a skilled service marketplace request to receive services by a skilled service provider. The various skilled service marketplace requesters 150 may interact with the system 1000 in different ways and may access different data and functionality of the system 1000. In one aspect, each type of skilled service marketplace requester 150 may interact with the system 1000 via different user interfaces 104, such as user interfaces 104a, 104b and 104c. As shown in FIG. 10, a skilled service provider 150b may provide or have access to capabilities, availability, service area, and performance metrics. The skilled service provider 150b may utilize the skilled service provider self-serve user interface 104b to access the skilled service provider management data store 1008. As shown in FIG. 10, an operations coordinator 150c can provide or have access to capabilities, availability, service area, and performance metrics. The operations coordinator 150c may utilize the administrator interface 104c to access the skilled service provider management data store 1008. Finally, as shown in FIG. 10, a customer 150a can provide or have access to demand for service stock keeping units (“SKUs”). The customer 150a may utilize an end-user interface 104a to access a user application data store 1010.

Returning to FIG. 1, the skilled service marketplace requester device 102 can also be referred to as a client processing device or a requester device. In one aspect, the skilled service marketplace requester device 102 may be a smartphone, tablet, desktop computer, laptop computers, thin client, or any other suitable device that can provide access to the system 100. The skilled service marketplace requester device 102 can be configured to run (or execute) processor-executable instructions (or commands). The skilled service marketplace requester device 102 may have a client user interface 104, a skilled service marketplace requester processor, a skilled service marketplace requester memory, a skilled service marketplace requester communication module, a global positioning system (GPS), a display, a physical keyboard, a personal area network device (e.g. BLUETOOTH), an audio device, a transceiver, and/or other features and combinations of features of client devices (e.g. a smartphone).

In one aspect, the client user interface 104 can allow a requester to interact with the skilled service marketplace requester device 102. The client user interface 104 may include any way a requester interacts with the skilled service marketplace requester device 102. For example, the client user interface can include a touch screen, a physical keyboard, a mouse, a microphone and speaker (e.g., an audio interface), a tactile interface (e.g., buttons, vibrations), and/or sensor interfaces (e.g., hall effect sensors, accelerometers, drop sensors, pressure sensors, etc.). In one aspect, the client user interface 104 may include a graphical user interface (GUI) displayed on a touch screen display of the skilled service marketplace requester device 102 that displays information in a graphical, human-comprehensible format. The GUI may include a plurality of input objects which allow the user to provide commands to the skilled service marketplace requester device 102 and output objects which allow the user to view outputs from the skilled service marketplace requester device 102. In one aspect, the output objects may be received from other parts of the system 100, such as scheduling engine 106. As depicted in FIG. 1, the scheduling engine 106 may include a user scheduling parameters processor, a qualified service providers filter, and a timeslot based service provider rank judge. In one aspect, the qualified service providers filter can be used to determine how many and which skilled service providers have the time to perform the skilled service marketplace request. In one aspect, the qualified service providers filter accounts for skilled technician travel time.

In one aspect, the GUI may be rendered by a web browser on the skilled service marketplace requester device 102. Examples of web browsers include, but are not limited to, Google Chrome, Apple Safari, Mozilla Firefox, and Microsoft Edge. In another aspect, the operating system of the skilled service marketplace requester device 102 can be configured to render, at least in part, a GUI on the client user interface 104 of the skilled service marketplace requester device 102.

The skilled service marketplace requester device 102 may be capable of running standalone applications (“apps”) created for use on the skilled service marketplace requester device 102. The apps can be similar to mobile browsers in that they can, at least in part, render GUIs or app screens, on the display of the respective skilled service marketplace requester device 102. The apps may have one or more app screens, which may have different GUI components. For example, the app screens can include information components or call to action components.

The skilled service marketplace requester memory can include read only memory (ROM); random access memory (RAM); persistent storage such as hard drives, solid state drives (SSD), optical disc drives and flash drives; and any other suitable memory device or combination of these elements. The skilled service marketplace requester memory may be configured, at least in part, for storing processor-executable instructions. These process-executable instructions can be configured to be executed by the one or more skilled service marketplace requester processors. The skilled service marketplace requester memory can store data generated or received by the skilled service marketplace requester device 102.

The skilled service marketplace requester processor can execute the operating system of the skilled service marketplace requester device 102, as well as applications thereon. In an aspect in which the skilled service marketplace requester device 102 includes two or more processors, the processors can operate in a parallel or distributed manner.

References to a “processor” throughout this disclosure may refer to QUALCOMM systems on a chip (SOC), APPLE A8 PROCESSORS, SAMSUNG SOCs, INTEL Mobile Processors, INTEL Laptop Processors, INTEL Desktop Processors, or any other suitable processor.

The GPS device may determine, at least in part, a location of the skilled service marketplace requester device 102 by communicating with a plurality of GPS satellites. The GPS device can perform known triangulation techniques to determine the GPS coordinates of the skilled service marketplace requester device 102. This may allow system 100 to determine a location of relevant skilled service providers relative to the skilled service marketplace requester 150 in order to schedule and monitor skilled service providers, for ongoing skilled marketplace scheduling. The skilled service marketplace requester device 102 may use any other suitable component for determining its location. For example, the skilled service marketplace requester device 102 can use WiFi triangulation, approximation of location by nearest WiFi hotspot, determining a general location from an IP address, or any other suitable location determining technique or component.

The skilled service marketplace requester communication device may allow the skilled service marketplace requester device 102 to communicate with another device (also known as a network-connected device) over a communications network. For example, the skilled service marketplace requester device 102 may communicate with a server (such as a skilled service provider management data store 108, a user application data store 110, or an analytics data warehouse 116), another skilled service marketplace requester device 102, or a cloud-connected hosted application. In one aspect, the skilled service marketplace requester communication device can include one or more wireless transceivers for performing wireless communication (e.g., WiFi, LTE, 5G) and one or more communication ports for performing wired communication (e.g., Ethernet). In another aspect, the skilled service marketplace requester communication device may communicate solely through wired connections or solely through wireless connections.

The system for skilled marketplace scheduling 100 may utilize hardware aspects of the skilled service marketplace requester device and skilled service marketplace provider device to improve the functionality of the system 100. In one aspect, GPS of the skilled service marketplace provider device may be used to determine schedule adherence and assess the skilled service provider's performance. For example, the skilled service provider's performance can be affected by whether the skilled service provider observes the rules of the road, is on time for an appointment in the skilled service provider service schedules, stays on preferred navigation paths to the appointment, or any other suitable factor. In another aspect, a camera on the skilled service marketplace requester device may be used to take pictures when an appointment is complete. The pictures can assist in determining the capabilities of the assigned skilled service providers. The pictures may also be used to confirm what parts have been used or taken away for a skilled service that utilizes parts and update the parts inventory.

The system 100 can interface with various third-party systems to improve its functionality. In one aspect, an inventory management system may be connected to hardware components of the system 100 to confirm elements of the skilled service (such as parts) are available at an expected location that is on skilled service provider's path to perform the service request. This confirmation may occur before scheduling and/or during performance of a scheduled service request.

The scheduling engine 106 may be implemented on one or more servers or client devices. In one aspect, the scheduling engine 106 may be a software or hardware component of the skilled service marketplace coordination system 1110. For example, the scheduling engine 106 may be implemented as a set of instructions stored in memory 1116 that can be executed by the processor 1112. The servers of the scheduling engine 106 can be configured to process requests from a skilled service marketplace requester device 102. A server may comprise many similar hardware components to skilled service marketplace requester device 102, such as a server processing device, a server communication device, and a server memory device. In one aspect, the server processing device may include two or more processors, the processors can operate in a parallel or distributed manner.

The server processing device may include a server memory. The server memory can store data generated or received by other parts of the system 100. The server memory can include ROM, RAM, a hard disc drive, an optical disc drive, a flash memory drive, or any other suitable memory component. The server memory may be distributed and located at multiple locations. The server memory may store processor-executable instructions and may communicate with one or more server processing devices that execute the processor-executable instructions. In one aspect, the server memory can store databases, other programs, and applications that the server may use to function.

The server communication device can allow the server to communicate with another network-connected device in the system 100. The server communication device can include one or more wireless transceivers for performing wireless communication and/or one or more communication ports for performing wired communication.

Returning to FIG. 1, the scheduling engine 106 may have internal applications and filters. The scheduling engine 106 may comprise or communicate with one or more data stores or server memory devices. As shown in FIG. 1, the scheduling engine 106 may communicate with a service provider management data store 108, a user application data store 110, and an analytics data warehouse 116. This communication may be done directly or indirectly. The data stores and server memory devices may interact via components of servers, such as app, which may allow operations on the data therein. In one aspect, these data operations may include ETL processes 112 and modelling engines 114.

In one aspect, the system for skilled marketplace scheduling 100 may include a simulation server, a scheduling server, and a plurality of skilled service provider devices. The simulation server may have a first processor and a first memory configured to perform a simulation procedure. The simulation procedure can return skilled service provider data. The skilled service provider data can be stored in the first memory. The scheduling server may have a second processor and a second memory configured to perform a scheduling procedure for a day. In one aspect, the simulation procedure can include calculating a skilled service provider Target Rate and the scheduling procedure may schedule the skilled service marketplace requests based on the actual skilled service providers' compensation for the day. The scheduling procedure may return a skilled service provider schedule. The skilled service provider schedule can include a set of skilled service marketplace requests for each skilled service provider in a set of skilled service providers. In one aspect, each skilled service provider device corresponds to a skilled service provider in the set of skilled service providers. Each skilled service provider device may have a processor and a memory configured to receive a skilled serviced provider schedule. In one aspect, the scheduling procedure may include obtaining third party information. In one aspect, the third party information can include tool and/or part availability and the location of each skilled service provider in the set of skilled service providers.

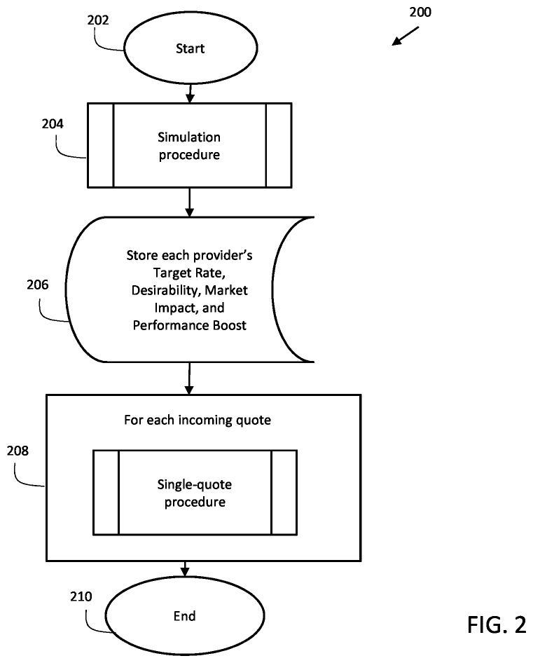

FIGS. 2-9 illustrate flowcharts of a method for skilled marketplace scheduling performed by the system for skilled marketplace scheduling 100 according to one aspect.

FIG. 2 depicts a method for skilled marketplace scheduling 200 according to one aspect. The method 200 is a high-level description of the function of the system for skilled marketplace scheduling 100 according to one aspect. In one aspect, the method 200 may be performed on the skilled service marketplace coordination processor. In one aspect, the method 200 may be focused on successful outcomes for the skilled service providers as a way to perform scheduling and achieve desirable system performance. The method 200 begins at step 202. At step 204, the skilled service marketplace coordination processor performs a simulation procedure that results storing data in the skilled service marketplace coordination memory (step 206). The simulation procedure may generate a skilled service providers' Target Rate, Desirability, Market Impact, and Performance Boost to serve as an input to the real time scheduler (such as scheduling engine 106). The Performance Boost may alternately be referred to as boost. The Performance Boost may be defined as a factor to accelerate the rate at which a skilled service provider can attain their Target Rate.

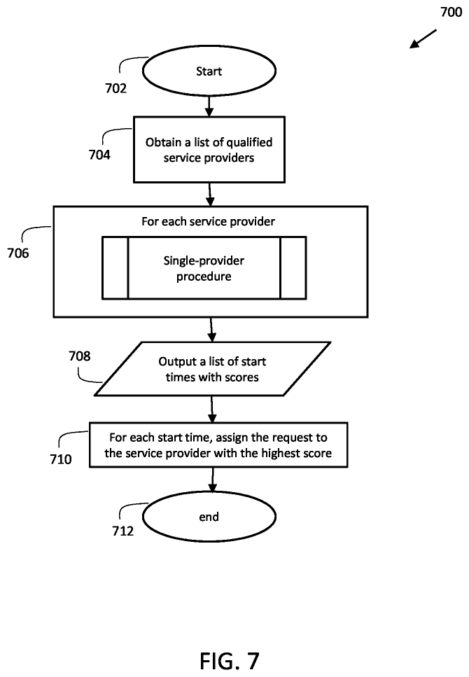

In one aspect, the skilled service marketplace coordination processor can collect inputs to determine a target rate for each service provider. Step 204. The skilled service marketplace coordination processor may store the inputs in the skilled service marketplace coordination memory and may recall and use them for scheduling as new skilled service marketplace request are received. Step 206. The simulation procedure is described in more detail with reference to FIGS. 3-6. At step 208, the skilled service marketplace coordination processor may perform a single-quote procedure. The single-quote procedure is described in more detail with reference to FIGS. 7-9. After performing the single-quote procedure, the skilled service marketplace coordination processor ends the method 200. Step 210.

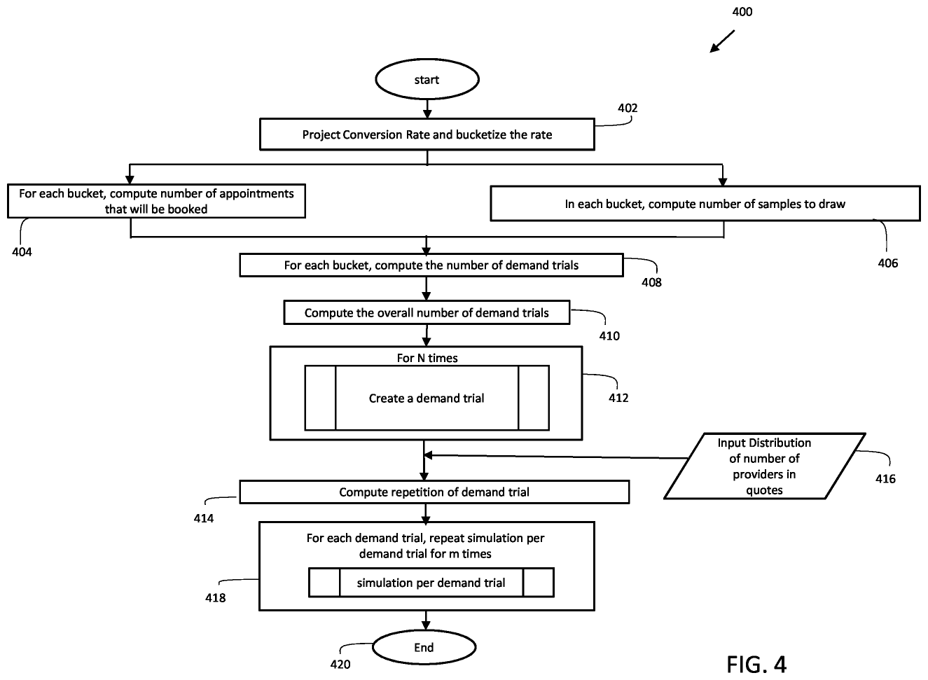

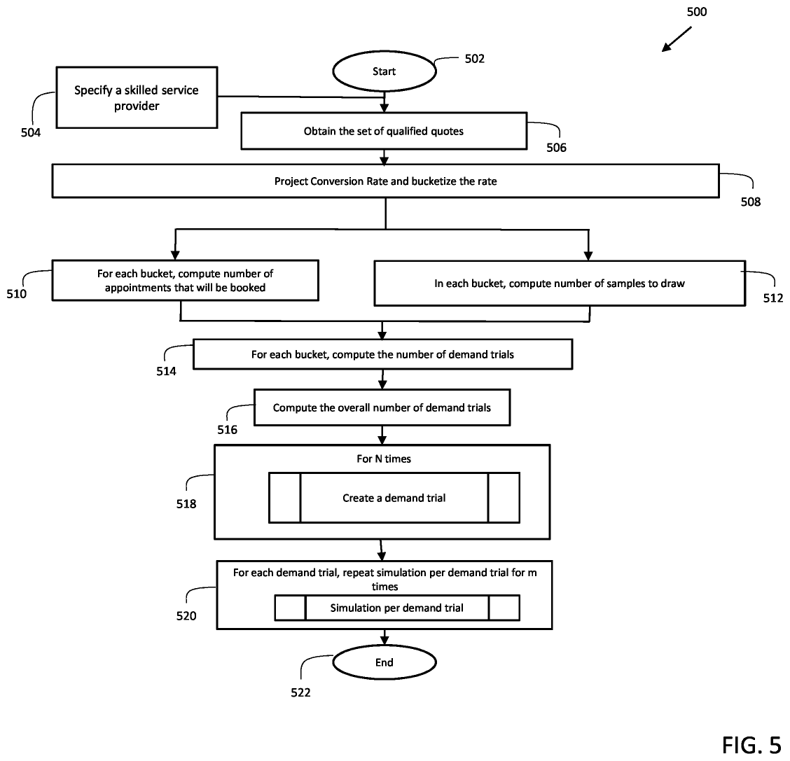

FIGS. 3-6 depict the construction of simulations of the simulation procedure given a specific market according to one aspect. In FIG. 3, an overview of the simulation procedure 300 according to one aspect is shown. The simulation procedure 300 can be performed by the skilled service marketplace coordination processor. The simulation procedure 300 may include two sets of simulations: (1) an all-provider simulation considering all skilled service providers competing for the demand in the market (shown in one aspect in FIG. 4), and (2) a single-provider simulation considering each single skilled service provider as the only skilled service provider in the market (shown in one aspect in FIG. 5). In one aspect, comparing the results of the all-provider simulation for a given skilled service provider with the single-provider simulation for that service provider can show the impact of the market on that service provider. Both the all-provider simulation and the single-provider simulation may be run according to three scenarios: (1) full availability (“FA”); (2) real availability (“RA”); and (3) real performance (“RP”), which is depicted in the simulation per demand trial flow chart.

FA may also be referred to as the top level of compensation based on the skilled service provider's skillset. In the FA scenario, the skilled service marketplace coordination processor may assume that every skilled service provider has 14 hours per day available and is available 7 days per week. RA may also be referred to as the target rate based on the skilled service provider's availability. In the RA scenario, the skilled service marketplace coordination processor can assume that every skilled service provider uses their actual calendar for the given time period. In one aspect, the given time period is one week. In the RP scenario, the skilled service marketplace coordination processor calculates how many hours each skilled service provider can earn money. The RP scenario may account for Skilled Service Provider Yield/Performance. In one aspect, the skilled service marketplace coordination system may use the difference in the number of appointments for a given service provider in each of the three scenarios to encourage the service provider to increase their availability in order to increase their compensation. Each of the three scenarios is described in more detail below with reference to FIG. 3.

Returning to FIG. 3, the simulation procedure 300 to determine a Target Rate for each skilled service provider is shown according to one aspect. The simulation procedure 300 may utilize some or all of the following inputs to calculate the target rate: (1) skilled service marketplace request(s); (2) a Conversion Rate; (3) a Skilled Service Provider Availability; (4) Skilled Service Provider Capabilities; (5) External Time Commitments of skilled service providers; (6) Pay Rate; (7) Labor Time; and (8) Skilled Service Provider Yield/Performance.

The Conversion Rate may alternately be referred to as a conversion or a quote conversion rate. The Conversion Rate can be defined as:

$$\frac{Number of appointments booked}{\begin{matrix}Number of skiled service marketplace \\ requests made by the requester\end{matrix}}$$

The Skilled Service Provider Availability may be defined as the calendar time that a skilled service provider has marked available for serving customers. In one aspect, the Skilled Service Provider Availability can change over time. In one aspect, the Skilled Service Provider Availability may be dense or sparse.

The Skilled Service Provider Capabilities can include a skill, tool, restriction, and/or preference of each skilled service provider. Skilled Service Provider Capabilities may be matched with skilled service marketplace request characteristics to determine whether the skilled service provider is eligible to perform a given service.

The External Time Commitments of skilled service providers may alternately be referred to as skilled service provider external commitments. The External Time Commitments of skilled service providers can be defined as commitments that fall outside the Skilled Service Provider Availability that have also been marked by the skilled service provider as times where their Skilled Service Provider Availability cannot be expanded.

The Pay Rate can be defined as the rate at which the skilled service provider is compensated for their service. For example, Pay Rate can refer to an hourly rate charged by the skilled service provider or a fixed amount for a particular service or service category. The amount of the Pay Rate can vary according to a number of different factors, for example, Pay Rate can vary based upon the particular service being rendered, the subject of the service, or other factors, or any combination thereof. For example, in the skilled marketplace of auto mechanics, the Pay Rate may vary based upon the specific vehicle service being rendered and/or the specific make/model of the vehicle being serviced.

The Labor Time may be defined as the duration of the skilled service marketplace request.

The Skilled Service Provider Yield/Performance can be defined as:

$$\frac{Number of hours completed}{\begin{matrix}Number of hours booked for the \\ skilled service provider\end{matrix}}$$

The method 300 can result in various outputs. The outputs may be stored in the service provider management data store 108. In one aspect, the service provider management data store 108 may be the skilled service marketplace coordination memory. The outputs may include may include the following items: (1) Target Rate; (2) Desirability for Availability; (3) Desirability for Performance; (4) Overall Desirability; (5) Market Impact; (6) Performance Boost; and (7) Minimum Useful Time.

The Desirability for Availability can be defined as a number that measures the desirability of a skilled service provider in a market with regard to the amount of time they are making available for services. In one aspect, the Desirability for Availability may be higher when the skilled service provider has more Skilled Service Provider Availability.

The Desirability for Performance may be defined as a number that measures the desirability of a skilled service provider in a market with regard to their performance on completion of booked work (skilled service marketplace requests). In one aspect, the Desirability for Performance may be higher when the skilled service provider completes more skilled service marketplace requests.

The Overall Desirability may be defined as an overall measure of desirability of a skilled service provider while accounting for both Desirability for Availability and Desirability for Performance.

The Market Impact can be defined as the market share retained by a skilled service provider in comparison to the other skilled service providers, also referred to as their competitors, in a single service provider scenario versus a multiple service provider scenario.

The Minimum Useful Time may be defined as or based upon the minimum Labor Time that a skilled service provider is able to perform. Every service provider has skills for a set of jobs that they are able to provide. Each job can take a different amount of time to complete. Minimum Useful Time refers to a metric describing the amount of time for the shortest job that a particular service provider can perform. This value can influence the minimum size of schedulable time-blocks for the skilled service provider's calendar. By maintaining Minimum Useful Time for each skilled service provider (e.g., tracking the shortest job that particular service provider can perform), fragmentation of scheduling can be reduced. In some aspects, the Minimum Useful Time may refer to the minimum useful time for the average length job (or another categorization of job) instead of the shortest job. Further, in some aspects, the Minimum Useful Time may include a travel time factor, for example the travel time factor can account for an average (or other metric) amount of time to travel to a service site within the service area.

The exemplary method of computing each provider's Performance Boost 300 of FIG. 3 will now be described in more detail. The method 300 illustrates an exemplary simulation procedure that converts the inputs listed above into the Target Rate for each skilled service provider. This method can be triggered by step 204 of method 200 of FIG. 2. The skilled service marketplace coordination processor may project the quoted demand in a market based on the recent past profile. Step 302. The quoted demand may refer to the number of skilled service marketplace requests in a given market in a given time period. The skilled service marketplace coordination processor can obtain the skilled service marketplace requests from the skilled service marketplace requester devices in a recent time period in a given market. Conversion Rate for demand refers to the rate at which a request is converted to an appointment with one of the service providers. The skilled service marketplace coordination processor may sort the quoted demand into several Conversion Rate intervals and generate trials of bookings. In order to maintain an appropriate representative demand sample in the simulation trials, the demand is broken up into logical groups that can be sampled for the individual trials. For example, this can be done by breaking the quoted demands up into intervals of Conversion Rates. For example, in the skilled marketplace of auto mechanics, oil changes, brake jobs, and car not starting requests may have a Conversion Rate of 30%, 50%, and 50% respectively. The brake jobs and car not starting requests may be grouped together because they are in the same interval of Conversion Rates. Depending on the application, another metric or a combination of metrics may be chosen to accomplish the grouping. Once the groups are established, trials can be run to simulate the conversion of the demand into bookings.

The skilled service marketplace coordination processor can construct the simulation to consider all existing service providers in the market and assign bookings to skilled service providers in three scenarios. The skilled service marketplace coordination processor may construct the simulation by: (1) obtaining a list of skilled service providers (Step 304); (2) gathering services booked on each skilled service provider's calendar in the recent time period; and (3) gathering the skilled service provider's calendar availability in the recent time period. In one aspect, the simulations for different geographic regions can indicate the supply and demand for the geographic region. In one aspect, the simulations can determine the seasonality of skilled service marketplace requests in a geographic region.

At step 310, the skilled service marketplace coordination processor may perform the all-provider simulation. An exemplary all-provider simulation 400 is depicted in FIG. 4. At Step 402, the skilled service marketplace coordination processor can project a Conversion Rate. The skilled service marketplace coordination processor may separate the requests into separate buckets based on their Conversion Rate. Each bucket can include a number of quotes (nᵢ) and the Conversion Rate (pᵢ). In one aspect, the skilled service marketplace coordination processor can project the Conversion Rate by comparing the current wait time for a skilled service to historical conversion data at a similar wait time. The skilled service marketplace coordination processor may compute the number of appointments (aᵢ) that will be booked for each bucket. Step 404. In one aspect, the number of appointments may be calculated as:

aᵢ=nᵢ*pᵢ

The skilled service marketplace coordination processor can compute the number samples to draw (kᵢ) to make the Conversion Rate in a small confidence interval around the projected rate in each bucket. Step 406. The skilled service marketplace coordination processor can calculate the number of demand trials for each bucket. Step 408. In one aspect, the number of demand trials may be calculated as follows:

$$\frac{{k}_{i}}{{a}_{i}}$$

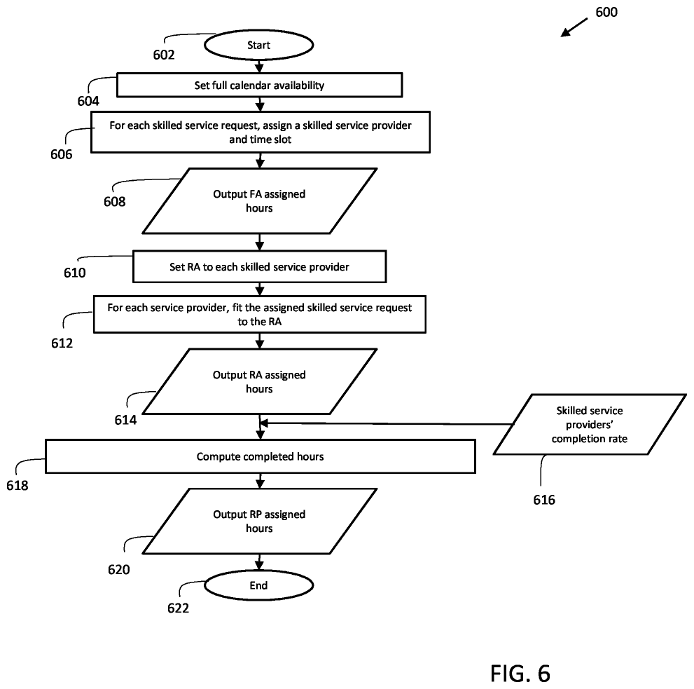

The skilled service marketplace coordination processor can compute the overall number of demand trials (N). Step 410. In one aspect, the overall number of demand trials can be calculated as the maximum of all buckets number of demand trials. For N times, the skilled service marketplace coordination processor may create a demand trial. Step 412. In one aspect the skilled service marketplace coordination processor may create a demand trial by randomly selecting aᵢ appointments from bucket i and combining all buckets. The skilled service marketplace coordination processor may then receive the Distribution of the number of providers in the skilled service marketplace requests. Step 416. The skilled service marketplace coordination processor can calculate the number of times a demand trial will be repeated (m). Step 414. That is, by selecting a sufficiently large repetition value, m, each qualified service provider can be ensured a fair (e.g., reasonable) chance at being selected in at least one of the trials. In one aspect, a fair chance at being selected may correspond to a confidence interval above 80%. For example, for a set of 7 skilled service providers, m can be selected as 61 to ensure each of the skilled service providers has a fair chance of being selected in at least one of the demand trials. In one aspect, a provider's chance of being assigned an assignment follows a “Discrete Uniform Distribution” and can be calculated accordingly. For each demand trial, the skilled service marketplace coordination processor may repeat the simulation per demand trial for m times. Step 418. An exemplary simulation per demand trial 600 is shown according to one aspect in FIG. 6. The skilled service marketplace coordination processor may then proceed to Step 420 which ends the all-provider simulation.

The skilled service marketplace coordination processor can begin the simulation per demand trial 600. Step 602. The skilled service marketplace coordination processor may assign full calendar availability for each skilled service provider. Step 604. For each skilled service marketplace request, the skilled service marketplace coordination processor may randomly choose a qualified and available skilled service provider. Step 606. The skilled service marketplace coordination processor can assign the skilled service request to the time slot in the chosen skilled service provider's calendar with the least waste. At Step 608, the skilled service marketplace coordination processor may output each skilled service provider's assigned hours using FA.

The skilled service marketplace coordination processor can set real availability for each skilled service provider. Step 610. For each skilled service provider, the skilled service marketplace coordination processor may fit the skilled service provider's assigned skilled service marketplace requests to the RA on the skilled service provider's calendar. Step 612. The skilled service marketplace coordination processor may output each skilled service provider's assigned hours using RA. Step 614.

The skilled service marketplace coordination processor may receive the skilled service provider's Completion Rate, which can be a ratio of the number of hours of completed services to the number of hours of assigned services. Step 616. The skilled service marketplace coordination processor may compute each skilled service provider's completed hours. Step 618. In one aspect, the skilled service provider's completed hours may be calculated as:

Completed Hours=Assigned Hours in RA*Completion Rate

The skilled service marketplace coordination processor may output each skilled service provider's assigned hours using RP. Step 620. The skilled service marketplace coordination processor may then proceed to Step 622 where the simulation per demand trial ends.

After performing the all-provider simulation, the skilled service marketplace coordination processor may return to Step 312 of FIG. 3. The skilled service marketplace coordination processor can calculate each skilled service provider's assigned hours in FA, RA, and RP from the all-provider's simulation. Step 312.

In the full availability (FA) scenario, the skilled service marketplace coordination processor may randomly pick one skilled service provider in a list of qualified skilled service providers for each skilled service marketplace request. A qualified skilled service provider is one whose skills, tools, availability, and service area meets the skilled service marketplace request characteristics. In the calendar of the selected skilled service provider, the skilled service marketplace coordination processor can find the time slot (i.e., a (day_idx, start_time) combination) with the lowest fragmentation score. The fragmentation score may be defined as a measure of how much a given skilled service marketplace request will fragment the skilled service provider's schedule if placed in a given time slot. The fragmentation score may be lowest when the given time slot creates the lowest number of time slots either before or after the skilled service marketplace request or when the time slots either before or after the skilled service marketplace request are sufficient for other skilled service marketplace requests. In other words, fragmentation can be reduced or minimized by either choosing slots at the ends of a time block or by choosing slots that break up a time block into usable pieces (at least as large as Minimum Useful Time) that can be booked for future requests. If more than one time slot has the lowest fragmentation score, the skilled service marketplace coordination processor can select the earliest time slot. If a time slot is found, the skilled service marketplace coordination processor may assign the skilled service marketplace request to this time slot and update the selected skilled service provider's calendar. Otherwise, the skilled service marketplace coordination processor may discard the skilled service marketplace request and deem it not feasible to be assigned. In one aspect, the skilled service marketplace coordination processor may notify the skilled service marketplace requester device that their skilled service marketplace request was discarded.

In the real availability (RA) scenario, the skilled service marketplace coordination processor may, for each skilled service provider go through each of the skilled service provider's assigned bookings and find the time slot with the lowest fragmentation score. If a time slot is found, the skilled service marketplace coordination processor may assign the booking (skilled service marketplace request) to this time slot and update the skilled service provider's calendar. Otherwise, the skilled service marketplace coordination processor can discard the quote and deem it not feasible to be assigned. In one aspect, the skilled service marketplace coordination processor may notify the skilled service marketplace requester device that their skilled service marketplace request was discarded.

In the real performance (RP) scenario, the skilled service marketplace coordination processor can calculate how many hours each skilled service provider can earn money utilizing the following formula:

Number of hours=Assigned hours in RA scenario*Completion Rate

The skilled service marketplace coordination processor may then proceed to step 314.

At step 320, the skilled service marketplace coordination processor may construct a single-provider simulation for each skilled service provider as though they are the sole skilled service provider in the market. Each skilled service provider also got assigned bookings by the FA, RA, and RP scenarios. An exemplary single-provider simulation procedure 500 is shown in one aspect in FIG. 5. In one aspect, the procedure 500 may be targeted to individual service providers, showing the service provider's desirability to provide hours and to complete skilled service marketplace requests.

The skilled service marketplace coordination processor may begin the single-provider simulation procedure 500. Step 502. The skilled service marketplace coordination processor can receive a specific skilled service provider on whom to perform the simulation. Step 504. The skilled service marketplace coordination processor can obtain a set of quote that this skilled service provider is qualified to perform. Step 506. At Step 508, the skilled service marketplace coordination processor can project a Conversion Rate. The skilled service marketplace coordination processor may separate the requests into separate buckets based on their Conversion Rate. Each bucket can include a number of quotes (nᵢ) and the Conversion Rate (pᵢ). In one aspect, the skilled service marketplace coordination processor can project the Conversion Rate by comparing the current wait time for a skilled service to historical conversion data at a similar wait time. For each bucket, the skilled service marketplace coordination processor may compute the number of appointments (aᵢ) that will be booked. Step 510. In one aspect, the number of appointments may be calculated as:

aᵢ=nᵢ*pᵢ

The skilled service marketplace coordination processor can compute the number samples to draw (kᵢ) to make the Conversion Rate in a small confidence interval around the projected rate in each bucket. Step 512. For each bucket, the skilled service marketplace coordination processor can calculate the number of demand trials. Step 514. In one aspect, the number of demand trials may be calculated as follows:

$$\frac{{k}_{i}}{{a}_{i}}$$

The skilled service marketplace coordination processor can compute the overall number of demand trials (N). Step 516. In one aspect, the overall number of demand trials can be calculated as the maximum of all buckets number of demand trials. For N times, the skilled service marketplace coordination processor may create a demand trial. Step 518. In one aspect the skilled service marketplace coordination processor may create a demand trial by randomly selecting aᵢ appointments from bucket i and combining all buckets. For each demand trial, the skilled service marketplace coordination processor may repeat the simulation per demand trial for m=1 times, since there is only a single service provider being considered. Step 520. The skilled service marketplace coordination processor can then perform a simulation per demand trial 600 like the one described above with reference to FIG. 6. The skilled service marketplace coordination processor may then proceed to Step 522 which ends the single-provider simulation.

After completing the single-provider simulation, the skilled service marketplace coordination processor may progress to Step 322 of FIG. 3. At step 322, the same procedures described above with respect to step 312 may be performed. The skilled service marketplace coordination processor may then proceed to Steps 314, with inputs from 322 and 312. In parallel, it may proceed to 324 with inputs from 322.

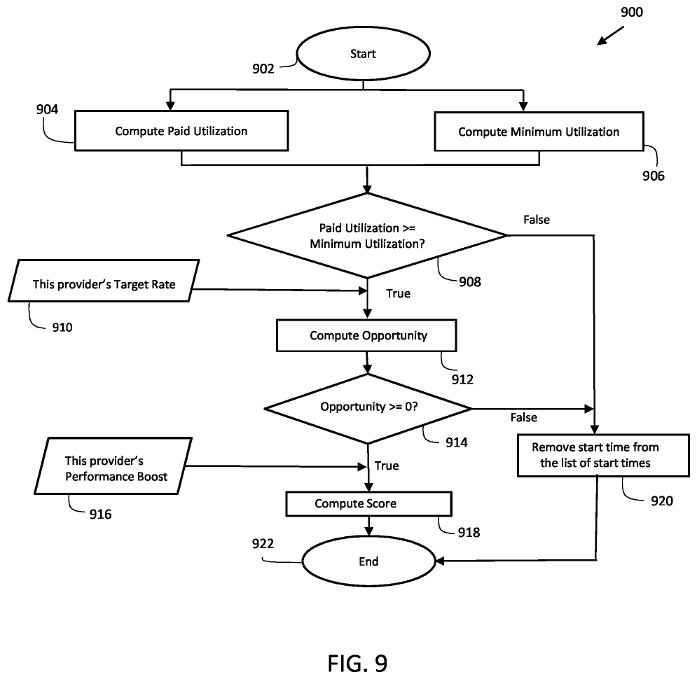

At step 314, the skilled service marketplace coordination processor can compute each skilled service provider's Market Impact. The skilled service marketplace coordination processor may compute each skilled service provider's Target Rate, Desirability for Availability (desirability to provide hours), and Desirability for Performance (desirability to complete jobs). Step 324. The skilled service marketplace coordination processor can compute the Target Rate by factoring the skilled service provider's pay rate by the proportion of fulfilled hours over the skilled service provider's calendar hours yields the Target Rate. The skilled service provider's fulfilled hours may be defined as the average of the assigned booked hours across multiple booking trials in the RP level outlined in FIG. 3. For example, if in 3 trials a skilled service provider had 10, 20 and 15 hours respectively, their fulfilled hours would be (10+20+15)/3=15 hours. The skilled service marketplace coordination processor can then calculate each skilled service provider's Score in the scheduling system. Step 316. Score may alternately be referred to as boosted opportunity score. Score is not related to opportunity cost (discussed in detail below with reference to FIG. 9). In order to perform this calculation, the skilled service marketplace coordination processor may derive the following metrics from the simulation results:

$$Desirability for Availability = \frac{Assigned hours in single service provider RA}{Assigned hours in serle service provider FA}$$

$$Desirability for Performance = \frac{Assigned hours in single service provider RP}{Assigned hours in single service provider RA}$$

$$Market Impact = \frac{Assigned hours in cannibalized FA}{Assigned hours in single service provider FA}$$

By specifying a weight to the Desirability for Performance (“DFP Weight”):

Desirability=DFP Weight*Desirability for Performance+(1−DFP Weight)*Desirability for Availability

In one aspect, the skilled service marketplace coordination processor may calculate the Score for each skilled service provider based on at least one of the Target Differential, Paid Utilization, Minimum Utilization, Opportunity, and Performance Boost.

The skilled service marketplace coordination processor may then complete simulation procedure 300 and return to method 200. Step 318. Returning to FIG. 2, the skilled service marketplace coordination processor can store each skilled service provider's Target Rate, Desirability, Market Impact, and Performance Boost in the skilled service marketplace coordination memory. Step 206. The skilled service marketplace coordination processor may the initiate the single-quote procedure 700 of FIG. 7 for each skilled service marketplace request.

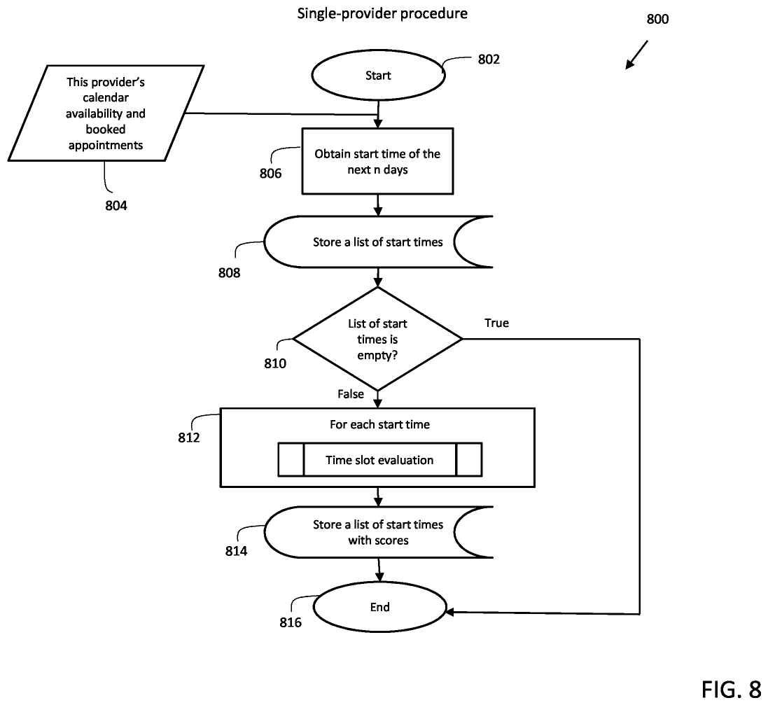

In FIG. 7, a single-quote procedure 700 according to one aspect is shown. The outputs of the simulation procedure 300 (stored in the skilled service marketplace coordination memory) may be used as inputs to the single-quote procedure 700. The single-quote procedure 700 starts at Step 702. The skilled service marketplace coordination processor can obtain a list of qualified skilled service providers for a given skilled service marketplace request. Step 704. In one aspect, the single-quote procedure 700 may include a sub-procedure to evaluate each qualified skilled service provider for the skilled service marketplace request (described in detail with reference to FIG. 8 and method 800). Step 706. In one aspect, the sub-procedure may evaluate each available start time for each available qualified skilled service provider. This evaluation according to one aspect is depicted in the time slot procedure flow chart (see FIG. 9 and method 900).

In FIG. 8, a single-provider procedure 800 according to one aspect is shown. The single-provider procedure 800 may be performed per skilled service provider. The skilled service marketplace coordination processor may start the single-provider procedure 800. Step 802. The skilled service marketplace coordination processor can receive this skilled service provider's calendar availability and booked appointments. Step 804. The skilled service marketplace coordination processor may obtain the start time for the given skilled service provider for the next n days. Step 806. At step 808, the skilled service marketplace coordination processor may store the list of start times in the skilled service marketplace coordination memory. The skilled service marketplace coordination processor may determine whether the list of start times is empty. Step 810. If the list of start times is empty, the skilled service marketplace coordination processor may proceed to step 816, which ends the single-provider procedure 800 and returns to the single-quote procedure 700. If the list of start times is not empty, the skilled service marketplace coordination processor can proceed to step 812. At step 812, the skilled service marketplace coordination processor performs a time slot evaluation procedure 900 for each start time.

In FIG. 9, a time slot evaluation procedure 900 according to one aspect is shown. The skilled service marketplace coordination processor may begin the time slot evaluation procedure 900. Step 902.

The skilled service marketplace coordination processor may compute Paid Utilization. Step 904. In one aspect, Paid Utilization may be calculated as follows:

$$\frac{Labor Time of this booking}{\begin{matrix}Schedule time of the booking + Travel time + \\ Unused available time\end{matrix}}$$

The schedule time may be the Labor Time padded with a non-negative amount of time to allow the skilled service provider time to prepare for and wrap up the skilled service request.

The skilled service marketplace coordination processor can compute Minimum Utilization. Step 906. This is the minimum utilization that the skilled service provider may achieve if they did not get any more bookings in the future. In one aspect, Minimum Utilization may be calculated as follows:

$$\frac{\begin{matrix}Labor Time in booked appointment in the time range + \\ Labor Time of this booking\end{matrix}}{Calendar availability in the time range}$$

The time range is a time window centered at the booked appointment date. In one aspect, the time window can be several days.

At Step 908, the skilled service marketplace coordination processor may compare the Paid Utilization with the Minimum Utilization. If the Paid Utilization is less than the Minimum Utilization, the skilled service marketplace coordination processor may proceed to Step 920. If the Paid Utilization is greater than or equal to the Minimum Utilization, the skilled service marketplace coordination processor can proceed to Step 912. The skilled service marketplace coordination processor may receive this skilled service provider's Target Rate. Step 910.

If the time interval being considered is in the past, the skilled service marketplace coordination processor can consider any remaining available time as unused available time. If the time interval being evaluated is in the future, the skilled service marketplace coordination processor may compare all available time intervals after the scheduling of the skilled service request in question to the Minimum Useful Time. If the available time interval is less than or equal to the Minimum Useful Time, the skilled service marketplace coordination processor can consider it unused available time. Otherwise, the skilled service marketplace coordination processor may not consider the available time interval unused available time because the available time interval is smaller than the shortest service this skilled service provider performs. The skilled service marketplace coordination processor can sum all unused available time across all time intervals in the considered time period to calculate the total unused available time.

In addition to unused available time, a skilled service provider may also have unpaid available time. Unpaid available time can be defined as the time a skilled service provider is available but is not performing a service they are paid for. Examples of unpaid available time include, but are not limited to, travel time to and from a service available time that was not booked by a customer, and fragmented time.

For each of the surviving skilled service providers from Step 908, the skilled service marketplace coordination processor may compute the Opportunity. Step 912. In one aspect, the Opportunity may be calculated as:

Opportunity=(Target Rate−Prospective Rate)−Opportunity Cost

wherein the Prospective Rate can be calculated as:

$$\frac{\begin{matrix}Earnings in booked appointments in the time range + \\ Expected earnings of this booking\end{matrix}}{Calendar availability in the time range}$$

wherein the time range is consistent with the time range in defining Minimum Utilization, and the Opportunity Cost can be calculated as:

$$Skilled service provider ' s Pay Rate * \\ \frac{Travel time + Unused Available Time}{Calendar availability in the time range}$$

The Prospective Rate may alternately be referred to as the minimum rate.

At Step 914, the skilled service marketplace coordination processor may determine whether the Opportunity is greater than or equal to zero. If the Opportunity is negative for this skilled service provider, the skilled service marketplace coordination processor can proceed to Step 920. If the Opportunity is greater than or equal to zero, the skilled service marketplace coordination processor may proceed to Step 918. The skilled service marketplace coordination processor can calculate this skilled service provider's Performance Boost. Step 916.

The Performance Boost may be constructed from the skilled service provider's Market Impact and Desirability from the simulation results. In one aspect, the following three parameters may be set before the Performance Boost is calculated: (1) Max Boost: a constant to specify the largest Performance Boost permitted in this particular system; (2) Desirability Quantile: the minimum quantile of Desirability that a skilled service provider is qualified to be boosted; and (3) Market Impact Quantile: the maximum quantile of Market Impact that the skilled service provider is qualified to be boosted. The Desirability to Market Impact Ration (“DM Ratio”) can be calculated as follows:

$$DM Ratio = \frac{Desirability}{Market Impact}$$

The Interpolated Boost may be defined as the Performance Boost interpolated to the range [1, Max Boost]. The Interpolated Boost can be calculated as follows:

$$1 + ( Max Boost - 1 ) * ( DM Ratio ) - \frac{min ( DM Ratio )}{max ( DM Ratio ) - min ( DM Ratio )}$$

If this skilled service provider's Desirability is above the Desirability Quantile and their Market Impact is below the Market Impact Quantile, the skilled service marketplace coordination processor may set the Performance Boost equal to the Interpolated Boost. Otherwise, the skilled service marketplace coordination processor may set the Performance Boost to a value of one.

At Step 918, the skilled service marketplace coordination processor may calculate this skilled service provider's Score. In one aspect, Score can be calculated as:

Score=Opportunity*Boost

In one aspect, the Scores computed at Step 918 may be one or more Scores for one or more skilled service providers.

The skilled service marketplace coordination processor can then proceed to Step 922 where the time slot evaluation procedure 900 ends. The skilled service marketplace coordination processor may return to the single-provider procedure 800.

At Step 920, the skilled service marketplace coordination processor may remove this start time from the list of start times. This removes this skilled service provider from this time slot because the skilled service marketplace request is not beneficial for the skilled service provider and will lower their Prospective Rate. If the Opportunity is negative for all skilled service providers, the skilled service marketplace coordination processor may hide this timeslot from requesters, because assigning this quote to any skilled service provider will take them further away from achieving their Target Rate. The skilled service marketplace coordination processor can then proceed to Step 922 where the time slot evaluation procedure 900 ends. The skilled service marketplace coordination processor may return to the single-provider procedure 800.

Returning to FIG. 8, the skilled service marketplace coordination processor may store a list of start times with Scores. Step 814. The skilled service marketplace coordination processor can proceed to step 816, which ends the single-provider procedure 800 and returns to the single-quote procedure 700.

Returning to FIG. 7, the skilled service marketplace coordination processor can output a list of start times with Scores. Step 708. In one aspect, the skilled service marketplace coordination processor may output a chosen skilled service provider for each available start time. Step 710. For each start time, the skilled service marketplace coordination processor may assign the skilled service marketplace request to the available qualified skilled service provider with the highest score. If there are no available start times, the skilled service marketplace coordination processor can return an empty result. The skilled service marketplace coordination processor may then end single-quote procedure 700 and return to method 200. Step 712. Returning to FIG. 2, method 200 can then end for this skilled service marketplace request. Step 210.

In one aspect, the method 200 may be affected by any or all of: (1) external dependencies; (2) the skilled service provider location; (3) the quality and performance of the skilled service providers; (4) the skilled service provider calendar availability and service area coverage; (5) Skilled Service Provider Capabilities; (6) service request characteristics; (7) unpaid available time; (8) predictable and consistent demand profile; (9) skilled service provider Pay Rate; (10) changes in customer behavior. External dependencies may include third parties, road conditions, and available parts, tools, and other job resources. The skilled service provider location may refer to both historical and real-time location. The quality and performance of skilled service providers may include manual and automated feedback from the skilled service providers and customers. The demand profile can be affected by various factors including, but not limited to seasonality, Distribution, or conversion. At high volumes, the customer behavior can be assumed to be consistent.

In one aspect, the method 200 can be designed to ensure that each skilled service provider maximizes their schedule.

Aspects of this disclosure include obtaining inputs, and confirming outputs, of scheduling problems to ensure proper performance of the system for scheduling skilled marketplace service providers. Related thereto, aspects of this disclosure improve the assignment of skilled service providers for available times for the requested service in order to maximize all the skilled service providers' compensation in a given market. Assuming that compensation linearly scales with the pay rate and revenue is closely correlated with skilled service provider labor time, this may also imply that the marketplace is able to generate the highest possible revenue in that market. The amount paid by the customer for the goods and services can be referred to as revenue.

The flowchart and block diagrams illustrate the architecture, functionality, and operation of possible implementations of systems, methods, and computer program products according to various aspects of the present invention. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Directional terms, such as “vertical,” “horizontal,” “top,” “bottom,” “upper,” “lower,” “inner,” “inwardly,” “outer” and “outwardly,” are used to assist in describing the invention based on the orientation of the aspects shown in the illustrations. The use of directional terms should not be interpreted to limit the invention to any specific orientation(s).

The above description is that of current aspects of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all aspects of the invention or to limit the scope of the claims to the specific elements illustrated or described in connection with these aspects. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed aspects include a plurality of features that are described in concert and that might cooperatively provide a collection of benefits. The present invention is not limited to only those aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The aspects of the invention in which an exclusive property or privilege is claimed are defined as follows:

1. A system for skilled marketplace scheduling, comprising:
a skilled service marketplace requester device including:
a skilled service marketplace requester communication module configured to:
transmit a skilled service marketplace request;
a plurality of skilled service marketplace provider devices, each of the plurality of skilled service marketplace provider devices including:
a skilled service marketplace provider communication module configured to:
transmit skilled service marketplace provider schedules; and
a skilled service marketplace coordination system including:
a skilled service marketplace coordination processor; and
a skilled service marketplace coordination communication module in communication with the skilled service marketplace coordination processor,
wherein the skilled service marketplace coordination processor calculates a plurality of available time slots for the skilled service marketplace request based on the skilled service marketplace provider schedules,
wherein the skilled service marketplace coordination processor calculates a target rate for each of a plurality of skilled technicians, and a prospective rate for each of the available time slots for each qualified and available skilled technician of the plurality of skilled technicians associated with the respective time slots, wherein the prospective rate for one of the plurality of skilled technicians is based upon the skilled technician's current rate and the rate for the skilled service marketplace request,
wherein the skilled service marketplace coordination processor calculates a target differential between the target rate and the prospective rate for each skilled technician in the set of available qualified skilled technicians, and
wherein the skilled service marketplace coordination processor assigns the skilled service marketplace request to the skilled technician in the set of available qualified skilled technicians with based upon the target differential.

2. The system of claim 1, wherein the skilled service marketplace coordination processor utilizes at least one of paid utilization, minimum utilization, opportunity, and performance boost to calculate the target differential.

3. A system for skilled marketplace scheduling, comprising:
a skilled service marketplace coordination system including:
a skilled service marketplace coordination communication module configured to:
receive skilled service marketplace requests;
receive skilled service marketplace provider schedules;
transmit skilled service requester appointment schedules; and
transmit skilled service provider service schedules;
a skilled service marketplace coordination processor, the skilled service marketplace coordination processor in communication with the skilled service marketplace coordination communication module; and
a skilled service marketplace coordination memory in communication with the skilled service marketplace coordination processor;
a skilled service marketplace requester device including:
a skilled service marketplace requester communication module configured to:
transmit a skilled service marketplace request; and
receive a skilled service requester appointment schedule;
a skilled service marketplace requester processor, the skilled service marketplace requester processor in communication with the skilled service marketplace requester communication module;
a skilled service marketplace requester memory, the skilled service marketplace requester memory in communication with the skilled service marketplace requester processor, the skilled service marketplace requester memory configured to store the skilled service requester appointment schedules; and
a plurality of skilled service marketplace provider devices, each of the plurality of skilled service marketplace provider devices including:
a skilled service marketplace provider communication module configured to:
transmit skilled service marketplace provider schedules; and
receive skilled service provider service schedules;
a skilled service marketplace provider processor, the skilled service marketplace provider processor in communication with the skilled service marketplace provider communication module; and
a skilled service marketplace provider memory in communication with the skilled service marketplace provider processor, the skilled service marketplace provider memory configured to:
store the skilled service marketplace provider schedules; and
store the skilled service provider service schedules;
wherein the skilled service marketplace coordination processor associates a skilled technician from among a plurality of skilled technicians with the skilled service marketplace request and associates an available appointment slot with the skilled service marketplace request,
wherein the skilled service marketplace coordination processor generates a skilled service marketplace coordination schedule based on the skilled service marketplace request and the skilled service marketplace provider schedules, the skilled service marketplace coordination schedule including the skilled service requester appointment schedule and the skilled service provider service schedules,
wherein the skilled service marketplace coordination memory stores the skilled service marketplace coordination schedule,
wherein the skilled service marketplace coordination communication module transmits the skilled service requester appointment schedule to the skilled service marketplace requester device and the skilled service marketplace requester memory stores the skilled service requester appointment schedules, and
wherein the skilled service marketplace coordination communication module transmits the skilled service provider service schedule to the skilled service marketplace provider device corresponding to the chosen skilled technician and the skilled service marketplace provider memory stores the skilled service provider service schedule.

4. The system of claim 3, wherein the skilled service marketplace provider schedule comprises:
a schedule of availability;
a compensation information;
a tools inventory; and
a skills inventory, the skills inventory including a list of certifications for the skilled technician.

5. The system of claim 4, wherein the schedule of availability is at least one of availability for an individual skilled technician and availability for a set of skilled technicians.

6. The system of claim 4,
wherein the skilled service marketplace coordination processor computes a list of expected skilled service marketplace requests in a first time period,
wherein the skilled service marketplace coordination processor determines a demand for a higher level of skill in the first time period from the list of expected skilled service marketplace requests,
wherein the skilled service marketplace coordination processor determines whether the demand for the higher level of skill will keep the skilled technicians with the skills inventory corresponding to the higher level of skill sufficiently busy in the first time period, and
wherein, upon receiving a skilled service marketplace request for a skilled service utilizing a lower level of skill in the first time period, the skilled service marketplace coordination processor selects a skilled technician with a lower level of skill if the skilled technicians with the skills inventory corresponding to the higher level of skill will be sufficiently busy with the demand for the higher level of skill in the first time period.

7. The system of claim 3,
wherein each of the skilled service marketplace requester communication module and the skilled service marketplace provider communication module transmit a geographic location to the skilled service marketplace coordination communication module, and
wherein the skilled service marketplace coordination processor uses the geographic locations to determine the skilled service marketplace coordination schedule.

8. The system of claim 7,
wherein the skilled service marketplace coordination processor uses the geographic location received from the skilled service marketplace requester device and the skilled service marketplace provider device to compute a skilled technician travel time, and
wherein the skilled service marketplace coordination processor selects a skilled technician from the plurality of skilled technicians to perform the skilled service marketplace request if the chosen skilled technician has a time available for both the skilled service marketplace request and the skilled technician travel time.

9. The system of claim 8, wherein the skilled service marketplace requests have a set of service characteristics, the set of service characteristics including:
a pre-determined amount of time to perform the requested service; and
a cost corresponding to the requested service.

10. The system of claim 3,
wherein the skilled service marketplace coordination memory stores a parts inventory,
wherein the skilled service marketplace coordination processor checks the parts inventory when it receives the skilled service marketplace request to determine whether a set of parts for the skilled service marketplace request are available in the parts inventory,
wherein the skilled service marketplace coordination communication module sends a service unavailable message to the skilled service marketplace requester communication module when the set of parts is not available in the parts inventory, and
wherein the skilled service marketplace coordination processor decrements the number of parts available in the parts inventory when the skilled service marketplace request is incorporated into the skilled service marketplace coordination schedule.

11. The system of claim 3,
wherein the skilled service marketplace coordination processor calculates a target rate for each of a plurality of skilled technicians, and a prospective rate for each of the available time slots for each qualified and available skilled technician of the plurality of skilled technicians associated with the respective time slots, wherein the prospective rate for one of the plurality of skilled technicians is based upon the skilled technician's current rate and the rate for the skilled service marketplace request,
wherein the skilled service marketplace coordination processor calculates a target differential between the target rate and the prospective rate for each skilled technician in the plurality of skilled technicians, and
wherein the chosen skilled technician per available time slot is chosen based upon the target differential.

12. The system of claim 3,
wherein the skilled service marketplace coordination processor calculates a target rate for each of a plurality of skilled technicians, and a prospective rate for each of the available time slots for each qualified and available skilled technician of the plurality of skilled technicians associated with the respective time slots, wherein the prospective rate for one of the plurality of skilled technicians is based upon the skilled technician's current rate and the rate for the skilled service marketplace request,
wherein the skilled service marketplace coordination processor calculates a target differential between the target rate and the prospective rate for each skilled technician in the plurality of skilled technicians,
wherein the skilled service marketplace coordination processor calculates a score for each skilled technician in the plurality of skilled technicians based on the target differential, paid utilization, minimum utilization, opportunity, and performance boost, and
wherein the chosen skilled technician per available time slot is selected based upon the score.

13. The system of claim 3, wherein the plurality of skilled technicians is a subset of all skilled technicians in the system that have a skills inventory corresponding to the skilled service marketplace request.

14. The system of claim 3, wherein the skilled service marketplace coordination processor determines the skilled service available appointment slots by:
compiling a list of all available appointment slots based on the skilled service marketplace provider schedules, and
filtering the list based on the opportunity cost for each appointment slot in the list of all available appointment slots.

15. A method of skilled marketplace scheduling, comprising:
receiving, at a skilled service marketplace coordination device, a skilled service marketplace request from a skilled service marketplace requester device;
receiving, at the skilled service marketplace coordination device, skilled service marketplace provider schedules from at least one of a plurality of skilled service marketplace provider devices;
determining, at the skilled service marketplace coordination device, a plurality of skilled service available appointment slots;
selecting, by the skilled service marketplace coordination device using the skilled service marketplace provider schedules, a chosen skilled technician to complete the skilled service marketplace request in one of the plurality of skilled service available appointment slots;
creating, by the skilled service marketplace coordination device, a skilled marketplace coordination schedule based on the skilled service marketplace request and the skilled service marketplace provider schedules, the skilled marketplace coordination schedule including skilled service requester appointment schedule and skilled service provider service schedules;
storing the skilled marketplace coordination schedule in a skilled service marketplace coordination memory of the skilled service marketplace coordination device;
transmitting the skilled service requester appointment schedule to the skilled service marketplace requester device; and
transmitting the skilled service provider service schedule to the skilled service marketplace provider device corresponding to the chosen skilled technician.
